(19) United States
(12) Patent Application Publication
(10) Pub. No.: US 2025/0269682 A1
(43) Pub. Date: Aug. 28, 2025

(54) WHEEL COMPONENT FOR A BICYCLE

(71) Applicant: DT SWISS INC., Grand Junction, CO (US)

(72) Inventor: Andreas HENIG, Biel (CH)

(21) Appl. No.: 19/059,681

(22) Filed: Feb. 21, 2025

(30) Foreign Application Priority Data
Feb. 22, 2024 (DE) 102024105067.5

(51) Int. Cl. B60B 1/04; B60B 1/02

(52) U.S. Cl. CPC B60B 1/044; B60B 1/0261; B60B 2310/204; B60B 2360/3412; B60B 2900/111; B60B 2900/141

(57) ABSTRACT

A wheel component of a bicycle, including a spoke nipple with a nipple body and two opposite end portions remote from one another, to detachably connect a spoke of a wheel with a rim or a hub of a wheel. One of the end portions forms a nipple head. The nipple body has a takeup for an end of a spoke. The takeup includes a thread for fastening a spoke. The nipple body is manufactured from a fibrous composite material and includes reinforcing elements and at least one matrix material. The nipple body includes a tool receiving element to enable setting and adjusting the spoke tension.

### BACKGROUND

The invention relates to a wheel component of a vehicle and, in particular, of a bicycle respectively a two- or multi-wheel vehicle, which in proper standard or normal operation is at least partially muscle-powered, and comprises a spoke nipple. The spoke nipple has a nipple body with two opposite end portions remote from one another, to detachably connect a spoke of a wheel with a rim and the hub of a wheel.

Spoke nipples are used in bicycles for fastening spokes, and may be inserted both in the rim and in the hub. Spoke nipples serve to support the spoke and to set and adjust the spoke tension. To this end, they are rotated by means of a tool, so as to screw the spoke nipple to the spoke, and to set the desired spoke tension, and to center the wheel.

The prior art has disclosed a great variety of spoke nipples. They are manufactured inexpensively in large quantities and are satisfactory in function. There is the drawback that, when steel spokes are used with aluminum rims, the different metals may result in corrosion reaction and damage.

It is therefore the object of the present invention to provide a wheel component with a spoke nipple providing more flexibility in use.

### SUMMARY

Further advantages and features of the present invention can be taken from the general description and the description of the exemplary embodiments.

A wheel component according to the invention of a vehicle and, in particular, of a two-or multi-wheel vehicle such as a bicycle, which in proper operation is at least partially muscle-powered, comprises a spoke nipple. The spoke nipple has a nipple body with two opposite end portions remote from one another, to detachably connect a spoke of a wheel with a rim or a hub of a wheel respectively to support a spoke of a wheel on a rim or a hub. One of the end portions, in particular, forms a nipple head. The nipple body has a takeup for a spoke end. The nipple body comprises on the takeup a thread for fastening a spoke. The nipple body comprises at least a tool receiving element to enable setting and adjusting the spoke tension. The nipple body is manufactured from a fibrous composite material and comprises reinforcing elements and at least one matrix material.

The wheel component according to the invention has many advantages. A considerable advantage of the wheel component according to the invention with a spoke nipple consists in the fact that a particularly low weight can be achieved.

Furthermore, the wheel component is flexible in use and can be employed in wheels provided for example with aluminum rims and/or steel spokes. Use is also possible in rims and/or spokes from a fibrous composite material. Use is also possible in combined environments such as steel spokes with a rim from a fibrous composite material.

In a preferred specific embodiment, the end portions are configured as one piece with the nipple body, each forming one end of the nipple body. Particularly preferably, at least some of the reinforcing elements are configured as reinforcing fibers. The reinforcing fibers may be configured as short fibers (shorter reinforcing fibers) or as long fibers (longer reinforcing fibers). Long fibers preferably extend nearly entirely, or entirely, through the length of the nipple body. Short fibers may be considerably shorter and have a length of for example between 0.2 mm and e.g. 5 mm or 10 mm.

Preferably, at least part of the reinforcing elements (in the spoke nipple) is formed by short fibers having a length which is shorter than half the length of the nipple body. Particularly preferably, short fibers have a length between 0.1 mm and 3 mm.

In preferred specific embodiments it is possible for at least part of the reinforcing elements to be formed by fiber bits or fiber reinforcing particles. Fiber bits may, in particular, be two-dimensional elements. Using short fibers is likewise conceivable. The reinforcing particles used may also be spherical elements, uneven particles, or powder particles.

In particularly preferred configurations, the matrix material of the spoke nipple is uniform overall. This means that the entire spoke nipple contains the same matrix material respectively the same material type. In the case that spokes from a fibrous composite material are also used together with the spoke nipple, the matrix material is, in particular, identical to the matrix material of the spoke.

Preferably, the material of the reinforcing elements of the spoke nipple in the threaded portion or in the vicinity of the thread, differs from the material of the reinforcing elements farther remote from the thread grooves. Thus, the thread region can be reinforced still further.

In advantageous configurations, at least part of the reinforcing elements consists of a carbon fiber and/or glass fiber material.

In particularly preferred configurations, the proportion of reinforcing elements in the spoke nipple amounts to at least 20% or 25% or 30%. Proportions of 35% or more are likewise conceivable. The percentage indicated refers to the weight proportion of the reinforcing elements to the total weight of the spoke nipple.

Particularly preferably, the matrix material used is a thermoplastic matrix material.

Preferably, the nipple head comprises a thickening and a rounded end, to enable an angular orientation of the spoke nipple. Particularly preferably, the rounded end is configured on the nipple head, so that the nipple head allows an angular orientation in the case of a two-dimensional contact for example with a rim.

The nipple body has at least one tool receiving element, to enable setting and adjusting the spoke tension. To this end, the nipple body may have suitable surfaces, which are positioned for example in a specific orientation relative to one another, thus providing a square or hexagon or the like.

In preferred configurations, the nipple body is configured closed on the end opposite the takeup. Preferably, the thread is an internal thread. In the case of a closed end, the takeup is provided as a blind hole, in which the internal thread is disposed. The end may be entirely or partially closed.

The nipple head may have a rounded end, to allow an angular orientation. The nipple head may have a spherical shape, wherein the end may also be flattened.

A wheel component according to the invention is, in particular, manufactured by injection molding, wherein a fibrous composite material with a liquid matrix material and reinforcing elements is injected into a manufacturing mold. The fibrous composite material is allowed to cool, and ultimately the wheel component is removed.

In all the configurations, the invention is particularly preferably employed in vehicles and, in particular, bicycles which in normal and regular proper use are at least partially muscle-powered. The invention is, in particular, used in sports bicycles.

Further advantages can be taken from the exemplary embodiments which will be discussed below with reference to the enclosed figures.

### BRIEF DESCRIPTION OF THE DRAWINGS

The figures show in:

FIG. 1 a schematic illustration of a racing bicycle;

FIG. 2 a schematic illustration of a mountain bike;

FIGS. 3-7 schematic sectional views of spokes;

FIGS. 8-10 side views and a perspective view of a spoke; and

FIGS. 11-13 schematic views of a spoke nipple.

### DETAILED DESCRIPTION

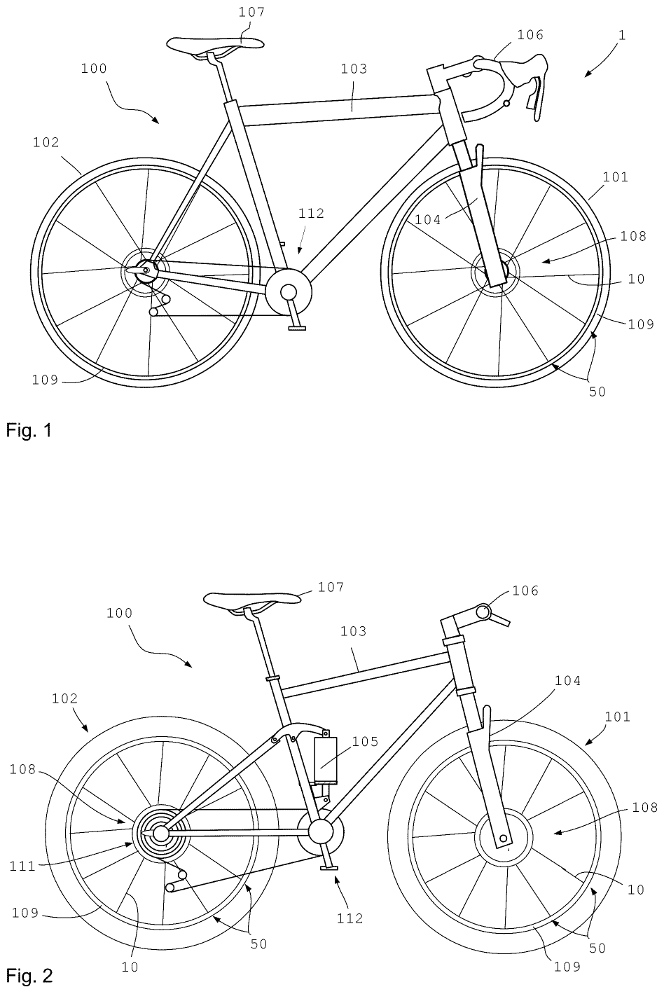

FIGS. 1 and 2 show a mountain bike and a gravel bicycle or racing bicycle 100 respectively, which are each equipped with wheel components 1 according to the invention. The mountain bike or racing bicycle 100 is provided with a front wheel 101 and a rear wheel 102.

The two wheels 101, 102 are provided with spokes 10. A sprocket device 111 is provided. Basically, conventional caliper brakes or other brakes, for example disk brakes may be provided.

The bicycles 100 are each provided with a frame 103, a handlebar 106, a saddle 107, a fork or suspension fork 104 respectively, and in the case of the mountain bike or a racing bicycle or gravel bicycle (gravel bike), a rear wheel damper 105 may be provided. A pedal crank 112 with pedals serves for driving. Optionally the pedal crank 112 and/or the wheels may be provided with an electric auxiliary drive. The hubs of the wheels may be attached to the frame by means of a clamping mechanism such as a through axle or a quick release.

The FIGS. 1 and 2 show the wheel component 1 according to the application with spokes 10 and spoke nipples 50. The spokes connect the hub 108 with the rim 109. The spoke nipples 50 shown are accommodated in the interior of the hollow rim 109, so as to be not visible in the side view.

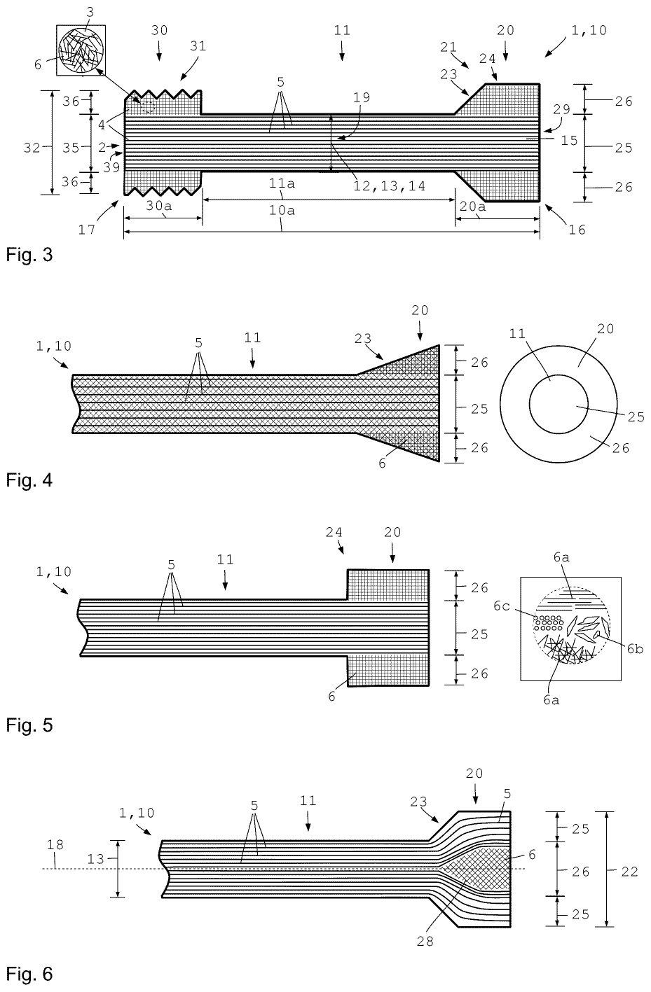

FIGS. 3 to 10 illustrate different wheel components 1 according to the application, configured as spokes 10. FIG. 3 illustrates a cross section of a spoke 10, comprising an elongated center portion 11 and two end portions 20, 30. The spoke 10 is configured integrally overall, and the spoke body 15 has no parting surfaces between the end portions 20, 30 and the center portion 11.

The spoke 10 consists of a fibrous composite material 2 and comprises a matrix material 3 and reinforcing elements 4. Long fibers 5 extend (at least nearly) completely over the length 10a of the spoke 10 centrally through the end portion 30, the center portion 11 and the end portion 20 at the other end of the spoke 10. At the very end, the long fibers 5 may be covered, so as to be invisible from the outside.

Reference is made to the fact that the FIGS. 3-10 depict the wheel component 1 with the spoke 10 not true to scale, so as to more clearly show every part and component of the spoke 10. In reality, the spoke 10 has a length 10a of for example 290 mm or 300 mm and, in a non-aerodynamic configuration, it may for example have a diameter between 1 mm and 3 mm or 4 mm. Other dimensions are likewise possible. These dimensions are also indicated so as to illustrate that the figures are not shown true to scale.

FIG. 3 shows that the end portion 30 has a threaded portion 31 configured as an external thread and extending across the entire width respectively length 30a of the end portion 30. The other end portion 20 has a conical portion 23 adjacent to the center portion 11, and a supporting or cylindrical portion 24 succeeding the conical portion 23 and reaching up to the spoke end.

In simple configurations, the center portion 11 is configured round, so that the minimum transverse dimension 12, the medium transverse dimension 13, and the maximum transverse dimension 14 each show the same value, and presently correspond to the diameter of the center portion 11. In other configurations, the spoke 11 may be configured e.g. aerodynamically, so that the minimum, medium, and maximum transverse dimensions 12-14 are different from one another.

The long fibers 5 extend over the entire length of the spoke 10 as reinforcing elements 4. The long fibers 5 in the end portions 20, 30 are located only in the (central) cross-sectional region 25 at the end portion 20 and the central cross-sectional region 35 at the end portions 30.

The cross-sectional portion 36, which likewise consists of a fibrous composite material 2 and has the same matrix material 3 as the center portion 11, follows the cross-sectional region 35 radially outwardly at the end portions 30.

Unlike the center portion 11 and the cross-sectional regions 25, 35, shorter reinforcing elements are employed in the cross-sectional portions 26, 36, which may consist of short fibers 6a or fiber bits 6b and/or reinforcing particles 6c. In the cross-sectional portions 26, 36 no reinforcing elements at all or only smaller/shorter reinforcing elements may be present.

In simple configurations, short fibers 6a are injection molded to the ends 16, 17, together with a matrix material 3, wherein, at least in this place, the matrix material 23 is first re-plasticated, if it had already (somewhat) solidified. This manufacturing process prevents the forming of separate boundary surfaces or adhesion surfaces or surfaces between the cross-sectional portion 36 and the cross-sectional region 35, inside of the matrix material 3. A transition between the cross-sectional region 35 and for example the cross-sectional portion 36 is adjustable only by modifying the embedded reinforcing material. This results in a particularly high stability under load of the wheel component 1 according to the application.

In the exemplary embodiment according to FIG. 3, the long fibers 5 are located in the central regions 29, 39 of the end portions.

FIG. 4 illustrates a slightly different exemplary embodiment of a wheel component 1 according to the application with a spoke 10, wherein only the end portion 20 and a part of the center portion 11 are depicted.

Unlike FIG. 3, the end portion 20 is configured conical overall. Again, the cross-sectional region 25 is interspersed with long fibers 5, while the cross-sectional portion 26 follows radially outwardly, having the same matrix material 3 but shorter reinforcing elements 6. Again, the end portion 20 forms the head portion 21 of the spoke 10, and serves to support the spoke on the rim or the hub.

As the schematic sketch on the right in FIG. 4 shows, both the center portion 11 and the end portion 20 are configured rotationally symmetrical in the exemplary embodiment according to FIG. 4. Again, it is possible for the center portion 11 to be configured aerodynamically, so that the cross sectional shape deviates from a circular shape.

FIG. 5 shows another variant of a spoke 10 as the wheel component 1, wherein the end portion 20 has no conical portion 23, but only an orthogonally protruding supporting or cylindrical portion 24.

On the right in FIG. 5, some examples of different reinforcing elements 6a, 6b and 6c are shown, which can be employed in the cross-sectional portion 26 at the end portion 20 (and in the cross-sectional portion 36 of the other end portion 30).

Both randomly placed shorter reinforcing elements 6a and unidirectional reinforcing elements 6a in short shapes, and fiber bits 6b in the same or different orientations, and reinforcing particles 6c, may be employed. A combination of different reinforcing elements 6a, 6b and 6c is likewise possible.

FIG. 5 shows only one end portion 20. The other end portion 30 may be configured identically. Alternately, both of the end portions 20, 30 (also) have a threaded portion 31. The shape of one or both of the end portions may be configured as illustrated in FIG. 3, 4 or 5. A wheel may comprise different spokes.

FIG. 6 shows a variant of a wheel component with a spoke 10, wherein, following the pultrusion, the end 16 is melted onto the end portion 20, and a cone-like element is inserted, wherein after removal, the cavity leaves a cone-like portion 28, which is filled up with a fibrous composite material 2 and a matrix material 3 and reinforcing elements 4. Centrally, the cross-sectional portion 26 with shorter reinforcing elements 6 is provided, while the long fibers 5 extend annularly around the cross-sectional portion 26 in the cross-sectional region 25. Overall, the end portion is widened to a diameter 22.

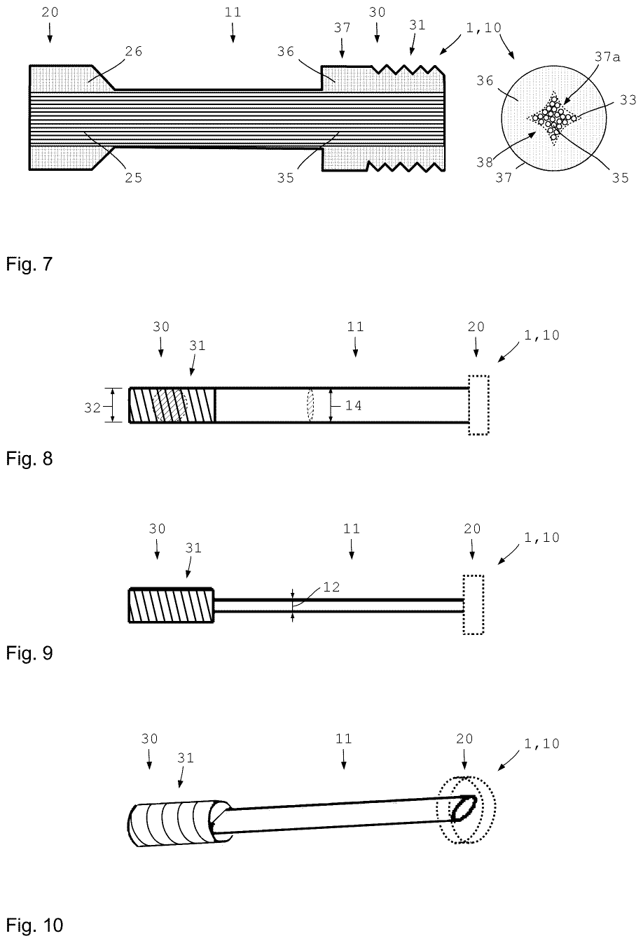

FIG. 7 shows another variant, wherein the end portion 30 is configured longer, respectively wherein the threaded portion 31 does not extend over the entire length of the end portion 30. An end portion 37 follows, configured cylindrically.

In FIG. 7, the long fibers 5 are again provided over the entire length of the spoke 10, virtually extending over the entire length of the end portions 20, 30 and the center portion 11.

FIG. 7 shows on the right a cross section in the end portion 37. One can clearly see that the reinforcing elements 4 disposed in a circle in the center portion 11, take a different cross sectional shape in the end portion 30 (and optionally, also in the end portion 20). Namely, the cross sectional shape is configured non-round, so as to form a deviating cross section 37a, similar to a rectangle, showing inwardly projecting bulgings in the side surfaces. The envelope curve 33 drawn in a broken line surrounds the reinforcing elements 4 the closest possible, and it is shown only for illustrating the shape. In reality, this envelope curve does not exist. It is not a separate layer. The spoke body is manufactured of one single material and is one-piece (monobloc). The cross sectional shape may also be referred to as star-shaped. This enables transmission of a higher rotational force, which is an advantage when setting the spoke tension.

Other deviating cross sectional shapes are also possible for the cross-sectional region respectively long fiber region 35, thus, its cross sectional shape may be triangular or oval or T-shaped or V-, or W-shaped or the like.

FIGS. 8-10 illustrate another wheel component with a spoke 10, FIGS. 8 and 9 showing two side views, clearly showing that the spoke 10 is configured aerodynamically, so that the minimum transverse dimension 12 is considerably smaller than the maximum transverse dimension 14 in the center portion 11.

An the ends 16, 17, the spoke 10 is once again configured round on the end portions 20, 30, and is provided with a threaded portion 31 at the end portion 30. The outer diameter 32 on the end portion 30 may correspond to the maximum transverse dimension 14 in the center portion 11.

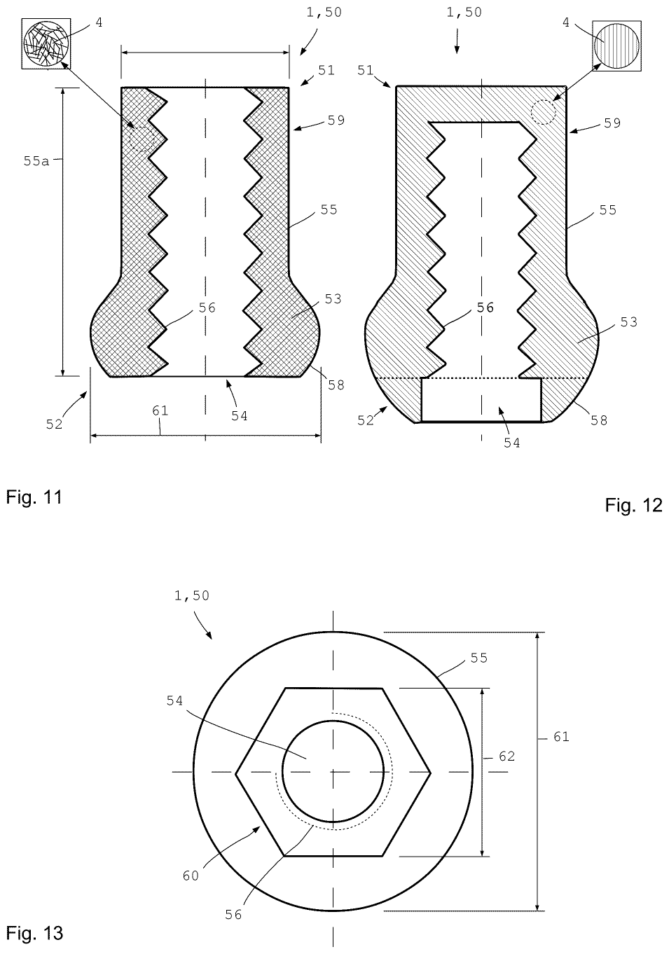

FIGS. 11, 12 and 13 illustrate a wheel component 1 according to the application with a spoke nipple 50. FIGS. 11 and 12 show two slightly different exemplary embodiments, each in cross section.

The spoke nipples 50 consist of a fibrous composite material 2 with a matrix material 3 and reinforcing elements 4. The reinforcing elements 4 may be configured as long fibers 5 or as shorter reinforcing elements 6.

The spoke nipple 50 is provided with a nipple body 55 extending over a length 55a, which may for example be 10 mm. Somewhat shorter and somewhat longer configurations are likewise possible. The nipple body 55 has a length 55a greater than the diameter 61 of the nipple body.

The nipple body is provided with end portions 51 and 52 on the ends 58 and 59. The nipple head 53 is configured rounded at the end 58, providing the contact surface, on which the nipple is for example supported on the rim.

The nipple head 53 is provided with a takeup 54 for the threaded end of a spoke. The takeup is configured with an internal thread 56. The nipple head 53 screws onto a spoke end by way of the thread 56. The takeup 54 may be configured as a through hole. It is also possible for the other end 51 to be partially or completely closed. Then, the takeup 54 is a blind hole.

FIG. 13 shows a top view of the end portion 51 of the spoke nipple 50. Thus, the tool receiving socket 60 with the wrench size 62 can be seen on the nipple body 55. In the center, the takeup 54 can be seen, in which the thread 56 is configured.

Employing spoke nipples 50 of a fibrous composite material provides a lighter-weight spoke nipple, which furthermore also reliably prevents possible contact corrosion between different metals. In particular, when employing reinforcing elements with a glass fiber content, these problems are reliably prevented.

All the configurations achieve a connection with an adhesive bond and of one single material (monobloc). A single and integral piece is provided.

In manufacturing spoke nipples 50, for example 20, 30, 40 or more cavities in a manufacturing mold can be filled concurrently, so that after manufacturing a mold, inexpensive manufacture is possible.

The thread in the wheel components is provided directly in the fibrous composite material.

While particular embodiments of the present wheel component for a bicycle have been described herein, it will be appreciated by those skilled in the art that changes and modifications may be made thereto without departing from the invention in its broader aspects and as set forth in the following claims.

### LIST OF REFERENCE NUMERALS

1 wheel component
2 fibrous composite material
3 matrix material
4 reinforcing elements
5 long fiber
6 shorter reinforcing elements
6a short fibers
6b fiber bits
6c reinforcing particles
7 longitudinal axis
10 spoke
10a length of
11 center portion
11a length of 11
12 transverse dimension (minimum)
13 transverse dimension (medium)
14 transverse dimension (maximum)
15 spoke body
16 end
17 end
19 central region
20 end portion
20a length of 20
21 head portion
22 outer diameter
23 conical portion
24 supporting, cylindrical portion
25 cross-sectional region
26 cross-sectional portion
28 cone-like portion
29 central region
30 end portion
30a length of 30
31 threaded portion
32 outer diameter
33 envelope curve
35 cross-sectional region, long fiber region
36 cross-sectional portion, short fiber portion
37 end portion
37a deviating cross section
38 cone-like portion
39 central region
50 spoke nipple
51 end portion
52 end portion
53 nipple head
54 takeup
55 nipple body
55a length
56 thread
58 end (rounded)
59 end (tool end)
60 tool receiving socket
61 diameter
62 wrench size
100 bicycle
101 wheel, front wheel
102 wheel, rear wheel
103 frame
104 fork, suspension fork
105 rear wheel damper
106 handlebar, handle
107 saddle
108 hub
109 rim
111 sprocket assembly
112 pedal crank

1. A wheel component of a vehicle, comprising a spoke nipple with a nipple body and two opposite end portions remote from one another, to detachably connect a spoke of a wheel with a rim or a hub of a wheel; wherein one of the end portions forms a nipple head; and wherein the nipple body has a takeup for an end of a spoke, and on the takeup, comprises a thread for fastening a spoke;
the nipple body is manufactured from a fibrous composite material and comprises reinforcing elements and at least one matrix material; and that the nipple body comprises a tool receiving element to enable setting and adjusting the spoke tension.

2. The wheel component according to claim 1, wherein the end portions are configured integrally with the nipple body and form an end each of the nipple body.

3. The wheel component according to claim 1, wherein at least some of the reinforcing elements are configured as reinforcing fibers and extend through the length of the nipple body.

4. The wheel component according to claim 1, wherein at least part of the reinforcing elements is formed by short fibers having a length which is shorter than half the length of the nipple body.

5. The wheel component according to claim 1, wherein at least part of the reinforcing elements is formed by fiber bits or reinforcing particles.

6. The wheel component according to claim 1, wherein the matrix material of the spoke nipple is uniform.

7. The wheel component according to claim 1, wherein the material of the reinforcing elements of the spoke nipple in the threaded portion differs from the material of the reinforcing elements remote therefrom.

8. The wheel component according to claim 1, wherein at least part of the reinforcing elements consists of carbon fiber and/or a glass fiber material.

9. The wheel component according to claim 1, wherein part of the reinforcing elements in the spoke nipple amounts to more than 20% or 25%.

10. The wheel component according to claim 1, wherein the matrix material comprises a thermoplastic matrix material.

11. The wheel component according to claim 1, wherein the nipple head comprises a thickening and a rounded end, to enable an angular orientation in the case of a two-dimensional contact of the nipple head for example with a rim.

12. The wheel component according to claim 1, wherein the nipple body is closed on the end opposite the takeup.

13. The wheel component according to claim 1, manufactured by injection molding, wherein a fibrous composite material with a liquid matrix material and reinforcing elements is injected into a manufacturing mold, the fibrous composite material is allowed to cool, and the wheel component is removed.
